(19) United States
(12) Patent Application Publication
(10) Pub. No.: US 2025/0223393 A1
(43) Pub. Date: Jul. 10, 2025

(54) RUBBER DIAPHRAGM, SOUND DEVICE AND APPLICATION THEREOF

(71) Applicant: AAC Microtech (Changzhou) Co., Ltd., Changzhou (CN)

(72) Inventors: Yuanwei Su, Changzhou (CN); Hongyuan Wang, Changzhou (CN); Hezhi Wang, Changzhou (CN); Chao Wang, Changzhou (CN)

(21) Appl. No.: 18/769,451

(22) Filed: Jul. 11, 2024

Related U.S. Application Data
(63) Continuation of application No. PCT/CN2024/071399, filed on Jan. 9, 2024.

(51) Int. Cl. C08F 293/00; C08L 23/08; H04R 7/26; H04R 9/06; H04R 31/00

(52) U.S. Cl. CPC C08F 293/005; C08L 23/0869; H04R 7/26; H04R 31/003; C08F 2438/03; C08L 2201/08; C08L 2312/00; H04R 9/06; H04R 2307/025

(57) ABSTRACT

Rubber diaphragm, sound device and application thereof are provided, rubber diaphragm contains distortion improving agent with mass percentage of 0.2-60%; distortion improving agent is block polymer, and end group or block component of distortion improving agent includes special chemical crosslinking point with mass fraction of 0.02-25%; number average molecular weight of block of distortion improving agent is 300-100000; and distortion improving agent or main structure thereof is accurately prepared through living polymerization. Rubber diaphragm contains distortion improving agent, and structure and content of special chemical crosslinking point are accurately controllable, so that position, height and width of damping peak of rubber diaphragm are accurately controllable, and damping characteristics of rubber diaphragm are accurately controllable. When rubber diaphragm is applied to sound device, distortion (THD) of low-frequency band is accurately reduced while maintaining good frequency response characteristics, and ensuring high in controllability, stable in performance and wide in application.

### TECHNICAL FIELD

The disclosure relates to the technical field of new materials, in particular to a rubber diaphragm, a sound device and application thereof.

### BACKGROUND

With the rapid development of electronic technology and the improvement of people's living standards, consumers have more and more requirements on the sound quality of sound devices. Reducing the distortion (THD) of the sound device in a specific frequency band improves the sound quality of the sound device, which is more important for researchers. The diaphragm material serves as an important component of the sound device, and the THD of the sound device may be remarkably reduced by regulating the structure and performance of the diaphragm material.

Rubber diaphragms are favored in the field of upper-class sound devices due to their own unique physical properties. How to accurately improve the performance of the rubber diaphragm and accurately reduce the THD of the sound device has attracted more and more attention.

Therefore, there is an urgent need in the art for a rubber diaphragm with accurately controllable damping, so as to accurately reduce distortion (THD) of a speaker.

### SUMMARY

An object of the present disclosure is to provide a rubber diaphragm, a sound device and application thereof, the rubber diaphragm has a precise structure, and may accurately adjust and control the damping performance of the rubber diaphragm, thereby accurately reducing the distortion (THD) of the sound device.

The technical solution of the present disclosure is as follows:

In a first aspect, the present disclosure provides rubber diaphragm, including a distortion improving agent with a mass percentage of 0.2-60%, the distortion improving agent is a block polymer, and an end group or at least one block component of the distortion improving agent comprises a special chemical crosslinking having a mass fraction of 0.02-25% and capable of having a chemical reaction; a number average molecular weight of each block of the distortion improving agent ranges from 300 to 100000; and the distortion improving agent may be accurately prepared through living polymerization or a main structure of the distortion improving agent is accurately prepared through living polymerization.

As an improvement, the block polymer is a diblock, triblock or multi-block polymer, and each block synergistically adjusts the distortion performance; the components of the block polymer are regularly arranged in the form of molecular segment.

As an improvement, the number average molecular weight of the block polymer is 1000-1000000.

As an improvement, the living polymerization comprises one of living radical polymerization, anionic polymerization, cationic polymerization or coordination polymerization.

As an improvement, the special chemical crosslinking point comprises one or more of double bond, triple bond, isocyanate group, silicon-hydrogen bond, silicon-chloride bond, azide group, epoxy group, nitrile group, siloxane, carboxyl group, hydroxyl group, amide group, amino group, acyl chloride bond or anhydride group.

As an improvement, the method for preparing the distortion improving agent comprises the following steps: providing a macromolecular chain transfer agent; uniformly mixing the macromolecular chain transfer agent with 2-ethylhexyl acrylate, an initiator and a first solvent to react at a first condition, removing the first solventto obtain an intermediate polymer after the reaction is; and uniformly mixing the intermediate polymer with hydroxyethyl acrylate, an initiator and a second solvent to react at the first condition, removing the second solvent after the reaction is finished to obtain the distortion improving agent.

As an improvement, the rubber diaphragm component further comprises, by mass, 150-200 parts by mass of main rubber, 2-5 parts by mass of reinforcing filler, 1.5-2.5 parts by mass of vulcanizing agent, 2-5 parts by mass of vulcanization aid, 2-3.5 parts by mass of anti-aging agent and 2-3 parts by mass of release agent.

In a second aspect, the present disclosure provides a sound device, including a voice coil, a magnetic circuit system, a support structure, and the rubber diaphragm as described above.

In a third aspect, the present disclosure provides an application of the sound device in an end product.

The present disclosure has the following beneficial effects:

The rubber diaphragm includes a distortion improving agent, the distortion improving agent is a block polymer, the structure of and the content of the special chemical crosslinking point of the distortion improving agent are accurately controllable, so that the position, the height and the width of a damping peak of the distortion improving agent are accurately controllable, and the damping characteristics of the obtained rubber diaphragm are accurately controllable. When the rubber diaphragm is applied to the sound device, the distortion (THD) of a low-frequency band may be accurately reduced while maintaining good frequency response characteristics, and meanwhile, it is high in controllability, stable in performance and wide in application range.

### BRIEF DESCRIPTION OF DRAWINGS

FIG. 1 is a 1H nuclear magnetic spectrum of symmetric trithiocarbonate obtained in embodiment 1;

FIG. 2 is a THD curve diagram of a speaker equipped with the rubber diaphragm obtained in embodiments 1-3 of the present disclosure and the rubber diaphragm in the prior art.

### DESCRIPTION OF EMBODIMENTS

The present disclosure is further described below with reference to the accompanying drawings and embodiments.

In a first aspect, the present disclosure provides rubber diaphragm, including a distortion improving agent with a mass percentage of 0.2-60%, the distortion improving agent is a block polymer, an end group or at least one block component of the distortion improving agent includes a special chemical crosslinking point with a mass fraction of 0.02-25% that may undergo a chemical reaction, that is, the end group of the block polymer or one block or two blocks or multiple block components include a special chemical crosslinking point with a mass fraction of 0.02%-25% that may undergo a chemical reaction; a number average molecular weight of each block of the distortion improving agent is 300-100000; and the distortion improving agent may be accurately prepared through living polymerization or a main structure of the distortion improving agent may be accurately prepared through living polymerization.

Due to the fact that the block polymer is prepared through living polymerization, the molecular structure is ensured to be accurately controlled, the structure of the obtained distortion improving agent block polymer is accurately controlled, the damping peak position, the height, the width and the accuracy and controllability are achieved, meanwhile, the content of special chemical crosslinking points is accurately controlled, and the damping performance of the prepared rubber diaphragm is accurately controlled. The speaker using the rubber diaphragm may accurately reduce the distortion (THD) of the low-frequency band while maintaining good frequency response characteristics, and is high in controllability, stable in performance and wide in application range. According to the sound device using the rubber diaphragm, the THD of the sound device is accurately and obviously reduced at a specific low-frequency band, the sound quality is improved, and meanwhile, the sound device has almost no influence on F0 and frequency response. The sound device has been applied to the fields of mobile phones, tablets, computers, earphones, automobiles, televisions, sound boxes and the like, so that the sound device has wide application prospects.

As an improvement, the block polymer is a diblock, triblock or multi-block polymer, and each block synergistically adjusts the distortion performance; the components of the block polymer are regularly arranged in the form of molecular segment.

As an improvement, the number average molecular weight of the block polymer is 1000-1000000.

As an improvement, the living polymerization comprises one of living radical polymerization, anionic polymerization, cationic polymerization or coordination polymerization.

As an improvement, the special chemical crosslinking point comprises one or more of double bond, triple bond, isocyanate group, silicon-hydrogen bond, silicon-chloride bond, azide group, epoxy group, nitrile group, siloxane, carboxyl group, hydroxyl group, amide group, amino group, acyl chloride bond or anhydride group.

As an improvement, the method for preparing the distortion improving agent comprises the following steps:
Primary polymerization: providing a macromolecular chain transfer agent; uniformly mixing the macromolecular chain transfer agent with 2-ethylhexyl acrylate, an initiator and a first solvent, and removing the first solvent after the reaction is finished under a first condition to obtain an intermediate polymer;
Secondary polymerization: after uniformly mixing the obtained intermediate polymer with hydroxyethyl acrylate, an initiator and a second solvent, and the reaction and the combination under the first condition, removing the second solvent to obtain the distortion improving agent. The first condition is specifically: introducing nitrogen for 20 min, and heating the mixture to 75° C.; and reacting for 1-5 h under the conditions of re-aeration and reflux condensation.
the intermediate polymer is prepared from 100 parts by mass of macromolecular chain transfer agent, 25-30 parts by mass of 2-ethylhexyl acrylate, 0.05-0.15 parts by mass of initiator AIBN and 200 parts by mass of first solvent;
100 parts by mass of intermediate polymer, 0.1-0.5 parts by mass of crosslinking agent, 0.001-0.005 parts by mass of initiator AIBN, and 150 parts by mass of second solvent; the crosslinking agent is preferably hydroxyethyl acrylate.

As an improvement, the rubber diaphragm component further comprises, 150-200 parts by mass of main rubber, 2-5 parts by mass of reinforcing filler, 1.5-2.5 parts by mass of vulcanizing agent, 2-5 parts by mass of vulcanization aid, 2-3.5 parts by mass of anti-aging agent and 2-3 parts by mass of release agent.

In a second aspect, the present disclosure provides a sound device, including the rubber diaphragm, the voice coil, the magnetic circuit system and the support structure as described above.

In a third aspect, the present disclosure provides an application of the sound device in an end product. The end product includes a mobile phone, a tablet, an earphone, a sound box, a smart watch, a computer, a sound box, a television, an automobile, or the like.

### Embodiment 1

S1, preparation of high purity RAFT chain transfer agent: symmetric trithiocarbonate, the synthetic route of symmetric trithiocarbonate is as follows:

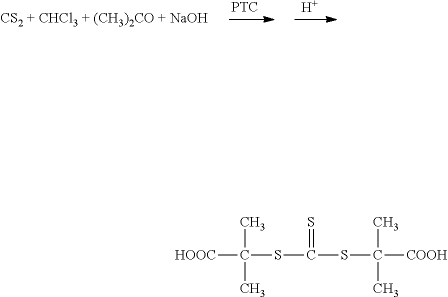

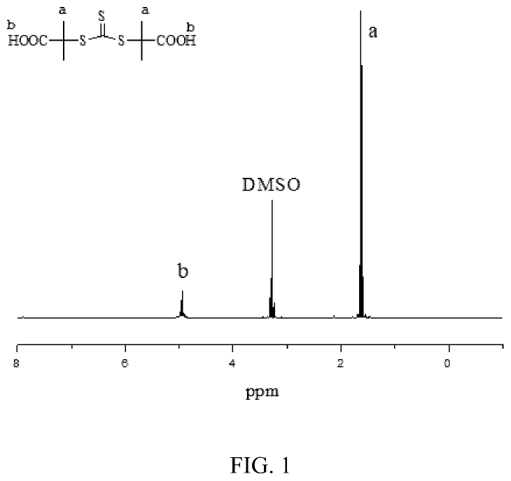

including steps of:
S11, 100 parts (by mass) of carbon disulfide, 400 parts by mass of chloroform, 200 parts by mass of acetone, 10 parts by mass of tetrabutylammonium bisulfate and 400 parts by mass of toluene were uniformly stirred at room temperature;
S12, the temperature was controlled in an ice bath, 800 parts by mass of 50 wt % sodium hydroxide solution was dropwise added into the solution, and the solution was gradually changed from colorless to red-brown; specifically, the temperature in the ice bath was controlled to react the mixed system in step S11 in an ice-water mixture;
S13, stirred overnight to form a black-red oil layer with strong smell on the upper layer, and a cloudy dark-yellow liquid on the lower layer;
S14, excess dilute hydrochloric acid was slowing added dropwise into the reaction solution, and the temperature in an ice bath was controlled to prevented the temperature from rising; standing, and suction filtration was performed to obtain a dark-yellow solid with strong smell; after the toluene/acetone solution was washed, the mass ratio of toluene to acetone was 4:1, and filtered to obtain a yellow solid; after vacuum drying, the structure was characterized by nuclear magnetism and mass spectrometry, the result was shown in FIG. 1, a represents

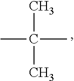

b represents —COOH, DMSO represents a solvent peak, and the coordinate ppm was a chemical displacement unit; which indicated that we successfully prepared a high purity RAFT chain transfer agent symmetric trithiocarbonate.

S2, preparation of the macromolecular chain transfer agent, including steps of:

100 parts by mass of styrene (by mass), 1 parts by mass of symmetrical trithiocarbonate prepared by the above preparation method, 0.1 parts by mass of initiator AIBN and 150 parts by mass of solvent were weighed and added into a reaction kettle for uniform mixing, nitrogen was introduced for 20 min, and the mixture was heated to 75° C.; the mixture was reacted for 1-5 h under the conditions of aeration and reflux condensation, and the solvent was removed to obtain the desired polystyrene.

S3, preparation of the distortion improving agent by free radical polymerization, including steps of:
S31, Primary polymerization: 100 parts by mass of obtained polystyrene, 30 parts by mass of 2-ethylhexyl acrylate, 0.05 parts by mass of initiator AIBN and 200 parts by mass of solvent were weighed and added into a reaction kettle for uniform mixing, nitrogen was introduced for 20 min, and the mixture was heated to 75° C.; the mixture was reacted under the conditions of aeration and reflux condensation for 1-5 h, and the solvent was removed to obtain an intermediate polymer;
S32, secondary polymerization: 100 parts by mass of the intermediate polymer, 0.1 parts by mass of the crosslinking agent hydroxyethyl acrylate, 0.001 parts by mass of the initiator AIBN and 150 parts by mass of the solvent were weighed and added into a reaction kettle for uniform mixing, nitrogen was introduced for 20 min, and the mixture was heated to 75° C.; the mixture for 1-5 h was reacted under the conditions of aeration and reflux condensation, and the solvent was reacted to obtain the distortion improving agent, which was recorded as distortion improving agent 1.

### Embodiment 2

Compared with embodiment 1, embodiment 2 differs in the preparation of the distortion improving agent, specifically:

100 parts by mass of obtained polystyrene, 25 parts by mass of 2-ethylhexyl acrylate, 0.01 parts by mass of initiator AIBN and 200 parts by mass of solvent were weighed and added into a reaction kettle for uniform mixing, nitrogen was introduced for 20 min, and the mixture was heated to 75° C.; the mixture was reacted under the conditions of aeration and reflux condensation for 1-5 h, and the solvent was removed to obtain an intermediate polymer;

100 parts by mass of the intermediate polymer, 0.2 parts by mass of hydroxypropyl acrylate, 0.002 parts by mass of the initiator AIBN and 150 parts by mass of the solvent were weighed and added into a reaction kettle for uniform mixing, nitrogen was introduced for 20 min, and the mixture was heated to 75° C.; the mixture for 1-5 h was reacted under the conditions of aeration and reflux condensation, and the solvent was removed to obtain the distortion improving agent, which was recorded as distortion improving agent 2.

### Embodiment 3

Compared with embodiment 1, embodiment 3 differs in the preparation of the distortion improving agent, specifically:

100 parts by mass of obtained polystyrene, 35 parts by mass of 2-ethylhexyl acrylate, 0.15 parts by mass of initiator AIBN and 200 parts by mass of solvent were taken and added into a reaction kettle for uniform mixing, nitrogen was introduced for 20 min, and the mixture was heated to 75° C.; the mixture was reacted under the conditions of aeration and reflux condensation for 1-5 h, and the solvent was removed to obtain an intermediate polymer;

100 parts by mass of the intermediate polymer, 0.3 parts by mass of hydroxybutyl acrylate, 0.004 parts by mass of the initiator AIBN and 150 parts by mass of the solvent were weighed and added into a reaction kettle for uniform mixing, nitrogen was introduced for 20 min, and the mixture was heated to 75° C.; the mixture was reacted under the conditions of aeration and reflux condensation for 1-5 h, and the solvent was removed to obtain the distortion improving agent, which was recorded as distortion improving agent 3.

### Embodiment 4

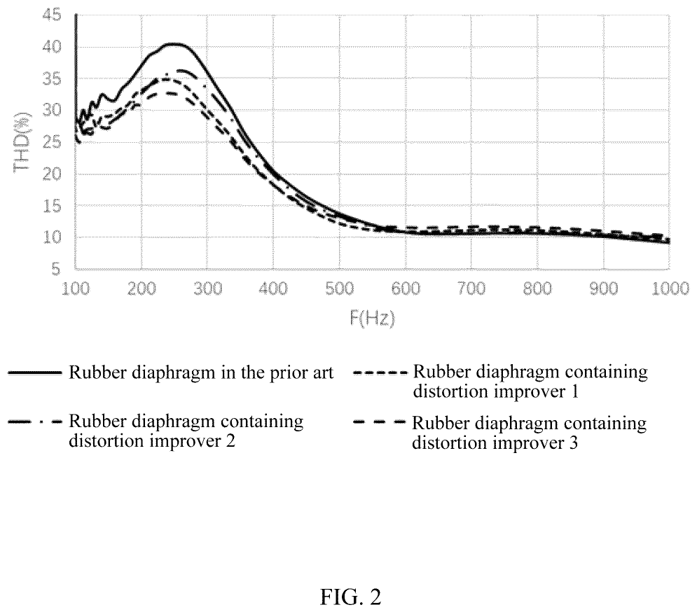

The main rubber was taken as AEM rubber as an example, the distortion improving agents obtained in embodiments 1-3 were respectively mixed according to Table 1, and the raw materials including the reinforcing filler, the vulcanizing agent, the vulcanization aid, the anti-aging agent, and the release agent were uniformly mixed to obtain a rubber compound; then, the rubber compound was pressed or coated into a sheet of about 100 μm by a rubber calendar, a flat vulcanizing machine or a coating machine, hot pressing was performed for 10 min at 200° C. and 0.2 MPa by using a diaphragm press to respectively obtain a rubber diaphragm in the prior art and rubber diaphragms containing distortion improving agents 1, 2, and 3; the rubber diaphragm in the prior art and the rubber diaphragms containing distortion improving agents 1, 2, and 3 were respectively installed to a speaker to obtain a corresponding speaker; then the distortion (THID) performance was tested, and the results were shown in FIG. 2.

| | | Rubber | Rubber | Rubber |
|---|---|---|---|---|
| | | containing | containing | containing |
| | Rubber | distortion | distortion | distortion |
| | in the | improving | improving | improving |
| | prior art | agent 1 | agent 2 | agent 3 |
| Vamac C | 100 | 100 | 100 | 100 |
| (ethylene acrylate | | | | |
| elastomer) | | | | |
| Naugard 445 | 2 | 2 | 2 | 2 |
| (anti-aging agent) | | | | |
| Armeen 18D | 2 | 2 | 2 | 2 |
| (release agent) | | | | |
| Vanfre VAM | 1.5 | 1.5 | 1.5 | 1.5 |
| (release agent) | | | | |
| Stearic Acid | 2 | 2 | 2 | 2 |
| Spheron SOA | 40 | 40 | 40 | 40 |
| SO N-550 | | | | |
| (DuPont AEM rubber) | | | | |
| DIAK NO. 1 | 1.5 | 1.5 | 1.5 | 1.5 |
| (vulcanizing agent) | | | | |
| Vulcofac | 2 | 2 | 2 | 2 |
| ACT55 | | | | |
| (vulcanizing agent) | | | | |
| Distortion improving | — | 10 | — | — |
| agent 1 | | | | |
| Distortion improving | — | — | 10 | — |
| agent 2 | | | | |
| Distortion improving | — | — | — | 10 |
| agent 3 | | | | |

As shown in FIG. 2, in the prepared speaker, compared with speaker equipped with the rubber diaphragm in the prior art, the total harmonic distortion value at the low-frequency band for the speaker equipped with the rubber diaphragm obtained by the technical solution of the present disclosure is small, the THD of the sound device is accurately and obviously reduced, the sound quality is improved, and at the same time, there is almost no influence on F0 and frequency response. The sound device has been applied to the fields of mobile phones, tablets, computers, earphones, automobiles, televisions, sound boxes and the like, so that the sound device has wide application prospects.

The above description is only an embodiment of the present disclosure, and it should be noted that those skilled in the art may further make improvements without departing from the concept of the present disclosure, but these all fall within the protection scope of the present disclosure.

What is claimed is:

1. A rubber diaphragm, comprising: a distortion improving agent with a mass percentage of 0.2-60%; wherein
the distortion improving agent is a block polymer, and an end group or at least one block component of the distortion improving agent comprises a special chemical crosslinking point having a mass fraction of 0.02%-25% and capable of having a chemical reaction; a number average molecular weight of one block of the distortion improving agent ranges from 300 to 100000; and the distortion improving agent is accurately prepared through living polymerization or a main structure of the distortion improving agent is accurately prepared through living polymerization.

2. The rubber diaphragm as described in claim 1, wherein the block polymer is a diblock, triblock or multi-block polymer, and each block synergistically adjusts distortion performance; components of the block polymer are regularly arranged in a form of a molecular segment.

3. The rubber diaphragm as described in claim 1, wherein a number average molecular weight of the block polymer is 1000-1000000.

4. The rubber diaphragm as described in claim 1, wherein the living polymerization comprises one of living radical polymerization, anionic polymerization, cationic polymerization or coordination polymerization.

5. The rubber diaphragm as described in claim 1, wherein the special chemical crosslinking point comprises one or more of double bond, triple bond, isocyanate group, silicon-hydrogen bond, silicon-chloride bond, azide group, epoxy group, nitrile group, siloxane, carboxyl group, hydroxyl group, amide group, amino group, acyl chloride bond or anhydride group.

6. The rubber diaphragm as described in claim 1, wherein the method for preparing the distortion improving agent comprises:
providing a macromolecular chain transfer agent;
uniformly mixing the macromolecular chain transfer agent with 2-ethylhexyl acrylate, an initiator and a first solvent to react at a first condition,
removing the first solvent to obtain an intermediate polymer after reaction is finished; and uniformly mixing the intermediate polymer with hydroxyethyl acrylate, an initiator and a second solvent, to react at the first condition, and
removing the second solvent after reaction is finished to obtain the distortion improving agent.

7. The rubber diaphragm as described in claim 1, further comprising 150-200 parts by mass of a main rubber, 2-5 parts by mass of a reinforcing filler, 1.5-2.5 parts by mass of a vulcanizing agent, 2-5 parts by mass of a vulcanization aid, 2-3.5 parts by mass of an anti-aging agent and 2-3 parts by mass of a release agent.

8. A sound device, comprising: a voice coil, a magnetic circuit system, a support structure, and a rubber diaphragm, wherein the A rubber diaphragm comprises: a distortion improving agent with a mass percentage of 0.2-60%; wherein
the distortion improving agent is a block polymer, and an end group or at least one block component of the distortion improving agent comprises a special chemical crosslinking point having a mass fraction of 0.02%-25% and capable of having a chemical reaction; a number average molecular weight of one block of the distortion improving agent ranges from 300 to 100000; and the distortion improving agent is accurately prepared through living polymerization or a main structure of the distortion improving agent is accurately prepared through living polymerization.

9. Use of the sound device as described in claim 8 in an end product.
